(19) United States
(12) Patent Application Publication
(10) Pub. No.: US 2024/0156576 A1
(43) Pub. Date: May 16, 2024

(54) TOOTH KEYPOINT IDENTIFICATION

(71) Applicant: SDC U.S. SmilePay SPV, Nashville, TN (US)

(72) Inventors: Jared Lafer, Nashville, TN (US); Ramsey Jones, Nashville, TN (US); Ryan Amelon, Nashville, TN (US)

(73) Assignee: SDC U.S. SmilePay SPV, Nashville, TN (US)

(21) Appl. No.: 17/984,442

(22) Filed: Nov. 10, 2022

(51) Int. Cl. A61C 9/00; A61C 7/00

(52) U.S. Cl. CPC A61C 9/0053; A61C 7/002

(57) ABSTRACT

Systems and methods for identifying tooth keypoints are disclosed. A method includes receiving digital representations comprising patient teeth, and identifying a first tooth outline from a first digital representation and a second tooth outline from a second digital representation. The method includes retrieving a 3D mesh comprising model teeth. The method includes projecting a first mesh boundary onto a patient tooth and modifying the first mesh boundary to match the first tooth outline. The method includes identifying a first tooth point on the first tooth outline that corresponds with a first mesh point on the first mesh boundary. The method includes mapping the first tooth point to the 3D mesh. The method includes determining that the first and second tooth points correspond to a common 3D mesh point. The method includes designating the first tooth point as a keypoint. The method includes modifying a digital representation based on the keypoint.

### TECHNICAL FIELD

The present invention relates generally to the field of dentistry and orthodontics, and more specifically, to systems and methods for identifying reliable keypoints on teeth, which are largely featureless objects, for purposes of further processing or analysis, including modeling teeth, treatment planning, and monitoring.

### BACKGROUND

Obtaining accurate digital representations of teeth for purposes of modeling a patient's teeth, planning orthodontic treatment to reposition a patient's teeth, and monitoring a patient's teeth during treatment typically requires the use of expensive 3D scanning equipment that is typically only available in dentist offices. However, obtaining digital representations that provide sufficient data to perform analysis on the teeth can be inconvenient and time consuming if the patient has to attend in-person appointments.

### SUMMARY

In one aspect, this disclosure is directed to a method. The method includes receiving, by one or more processors, a plurality of digital representations comprising a plurality of patient teeth. The plurality of digital representations comprise a first digital representation and a second digital representation. The method includes segmenting, by the one or more processors, the first digital representation and the second digital representation to identify a first tooth outline of a patient tooth from the first digital representation and a second tooth outline of the patient tooth from the second digital representation. The method includes retrieving, by the one or more processors, a 3D mesh of a dentition comprising a plurality of model teeth. The method includes projecting, by the one or more processors, a first mesh boundary of a model tooth of the plurality of model teeth onto the patient tooth from the first digital representation. The model tooth corresponds with the patient tooth. The method includes modifying, by the one or more processors, the first mesh boundary to match the first tooth outline. The method includes identifying, by the one or more processors, a first tooth point on the first tooth outline that corresponds with a first mesh point on the first mesh boundary. The method includes mapping, by the one or more processors, the first tooth point to the 3D mesh of the dentition. The method includes determining, by the one or more processors, that the first tooth point and a second tooth point correspond to a common 3D mesh point. The second tooth point has been mapped to the 3D mesh of the dentition based on the second tooth outline. The method includes designating, by the one or more processors, based on determining the first tooth point and the second tooth point correspond to the common 3D mesh point, at least one of the first tooth point or the second tooth point as a keypoint. The method includes modifying, by the one or more processors, at least one of the first digital representation or the second digital representation based on the keypoint.

In one aspect, this disclosure is directed to a system. The system includes one or more processors and a memory coupled with the one or more processors. The memory is configured to store instructions that, when executed by the one or more processors, cause the one or more processors to receive a plurality of digital representations comprising a plurality of patient teeth. The plurality of digital representations comprise a first digital representation and a second digital representation. The instructions cause the one or more processors to segment the first digital representation and the second digital representation to identify a first tooth outline of a patient tooth from the first digital representation and a second tooth outline of the patient tooth from the second digital representation. The instructions cause the one or more processors to retrieve a 3D mesh of a dentition comprising a plurality of model teeth. The instructions cause the one or more processors to project a first mesh boundary of a model tooth of the plurality of model teeth onto the patient tooth from the first digital representation. The model tooth corresponds with the patient tooth. The instructions cause the one or more processors to modify the first mesh boundary to match the first tooth outline. The instructions cause the one or more processors to identify a first tooth point on the first tooth outline that corresponds with a first mesh point on the first mesh boundary. The instructions cause the one or more processors to map the first tooth point to the 3D mesh of the dentition. The instructions cause the one or more processors to determine that the first tooth point and a second tooth point correspond to a common 3D mesh point. The second tooth point has been mapped to the 3D mesh of the dentition based on the second tooth outline. The instructions cause the one or more processor to designate at least one of the first tooth point or the second tooth point as a keypoint based on the first tooth point and the second tooth point corresponding to the common 3D mesh point. The instructions cause the one or more processors to modify at least one of the first digital representation or the second digital representation based on the keypoint.

In yet another embodiments, this disclosure is directed to a non-transitory computer readable medium that stores instructions. The instructions, when executed by one or more processors, cause the one or more processors to receive a plurality of digital representations comprising a plurality of patient teeth. The plurality of digital representations comprise a first digital representation and a second digital representation. The instructions cause the one or more processors to segment the first digital representation and the second digital representation to identify a first tooth outline of a patient tooth from the first digital representation and a second tooth outline of the patient tooth from the second digital representation. The instructions cause the one or more processors to retrieve a 3D mesh of a dentition comprising a plurality of model teeth. The instructions cause the one or more processors to project a first mesh boundary of a model tooth of the plurality of model teeth onto the patient tooth from the first digital representation. The model tooth corresponds with the patient tooth. The instructions cause the one or more processors to modify the first mesh boundary to match the first tooth outline. The instructions cause the one or more processors to identify a first tooth point on the first tooth outline that corresponds with a first mesh point on the first mesh boundary. The instructions cause the one or more processors to map the first tooth point to the 3D mesh of the dentition. The instructions cause the one or more processors to determine that the first tooth point and a second tooth point correspond to a common 3D mesh point. The second tooth point has been mapped to the 3D mesh of the dentition based on the second tooth outline. The instructions cause the one or more processors to designate at least one of the first tooth point or the second tooth point as a keypoint based on the first tooth point and the second tooth point corresponding to the common 3D mesh point. The instructions cause the one or more processors to modify at least one of the first digital representation or the second digital representation based on the keypoint.

### BRIEF DESCRIPTION OF THE DRAWINGS

FIG. 1 shows a schematic diagram of a system for tooth keypoint detection, according to an illustrative embodiment.

FIG. 2 shows a plurality of digital representations, according to illustrative embodiments.

FIG. 3 shows segmentation of a digital representation, according to an illustrative embodiment.

FIG. 4 shows a 3D mesh of a dentition, according to an illustrative embodiment.

FIG. 5 shows a diagram of a tooth keypoint identification process, according to an illustrative embodiment.

FIG. 6 shows a diagram of a method of identifying a tooth keypoint, according to an illustrative embodiment.

FIG. 7 shows a diagram of a method of identifying a tooth keypoint, according to an illustrative embodiment.

### DETAILED DESCRIPTION

Before turning to the figures, which illustrate certain example embodiments in detail, it should be understood that the present disclosure is not limited to the details or methodology set forth in the description or illustrated in the figures. It should also be understood that the terminology used herein is for the purpose of description only and should not be regarded as limiting.

Referring generally to the figures, described herein are systems and methods for detecting keypoints of a tooth from 2D images for modeling and image analysis, orthodontic treatment, and monitoring. More specifically, the systems and methods disclosed herein identify edge points of teeth in both 2D images and a 3D mesh and utilizes correspondences in those edge points to find keypoints. Those keypoints can be used to calculate multiple loss functions and ultimately create a 2D image that more accurately corresponds with the 3D mesh or create a 3D model that more accurately depicts a patient's dentition. The resulting 2D image or 3D model can be used to analyze the user's teeth, provide dental or orthodontic treatment including developing a treatment plan for repositioning one or more teeth of the user, manufacture dental aligners configured to reposition one or more teeth of the user (e.g., via a thermoforming process, directly 3D printing aligners, or other manufacturing process), manufacture a retainer to retain the position of one or more teeth of the user, monitor a condition of the user's teeth including whether or not the user's teeth are being repositioned according to a prescribed treatment plan, and identify whether a mid-course correction of the prescribed treatment plan is warranted, among other uses. As used herein, mid-course correction refers to a process that can include identifying that a user's treatment plan requires a modification (e.g., due to the user deviating from the treatment plan or the movement of the user's teeth deviating from the treatment plan), obtaining additional images of the user's teeth in a current state after the treatment plan has been started, and generating an updated treatment plan for the user.

According to various embodiments, a computing device analyzes one or more digital representations (e.g., 2D images) of a patient's dentition in conjunction with a template 3D mesh to identify keypoints. The keypoints are points that correspond with both the 3D mesh and the digital representation. For example, a point on a first digital representation can correspond with a point on the 3D mesh creating a 2D-3D correspondence. A point on a second digital representation can correspond with the same point on the 3D mesh. This can create a second 2D-3D correspondence and a 2D-2D correspondence between the first digital representation and the second digital representation. The computing device can perform a deformable edge registration to compare teeth in the digital representation with teeth in the 3D mesh that do not have the same geometry. For example, the 3D mesh may be a template 3D mesh such that the geometry of the mesh teeth do not have the same geometry as the teeth in the digital representation. The computing device may project a boundary of the 3D mesh onto a digital representation and modify the boundary to match an outline of a corresponding tooth. The boundary can be registered with the outline such that every point on the boundary corresponds with a point on the outline. The points on the outline may be mapped back to the 3D mesh based on the registration, creating a 2D-3D correspondence. The same can be done for additional and various digital representations. A keypoint may be identified when a point from an outline from a first digital representation maps back to the same 3D mesh point as a point from an outline from a second digital representation. The keypoints may be reliable points that can be used to perform various subsequent analysis of the teeth. For example, the computing device can use the keypoints to perform bundle adjustments or to adjust the digital representations or 3D mesh to better depict the actual state of the patient's dentition, among other operations.

The technical solutions of the systems and methods disclosed herein improve the technical field of identifying keypoints on relatively featureless objects, and devices and technology associated therewith. For example, the disclosed solution identifies a tooth edge in both a 2D image and a 3D mesh, and uses deformable edge registration to align the images and render a tooth down in a projected mesh using edge points and virtual camera parameters. The disclosed solution can identify strong correspondences between points on the 2D images and the 3D mesh based on matching edge points from the 3D mesh with various 2D images. These strong correspondences allow the system to identify reliable keypoints on relatively featureless objects (e.g., teeth). These keypoints can be used, for example, to update a position of a tooth and/or virtual camera parameters to minimize errors. The process may be repeated iteratively and eventually yield a sufficient number of keypoints such that there are no errors or such that any variances are within an acceptable threshold or degree of accuracy.

Additional benefits of the system include eliminating the need for obtaining a 3D model that is associated with a user by way of a 3D scan of the user's teeth. For example, the deformable registration allows points from a generic 3D mesh to correspond with points from a 2D image of a patient's dentition. The 3D mesh can be a generic or template 3D mesh, and therefore does not have to have the same shape as the dentition in the 2D image. This eliminates the need for 3D scanning equipment and reduces the amount of storage space needed in the system since the same template 3D model may be used for analysis of each individual user, and does not require storing a separate 3D mesh for each user, even though each user will naturally have teeth that are arranged and shaped different from other users.

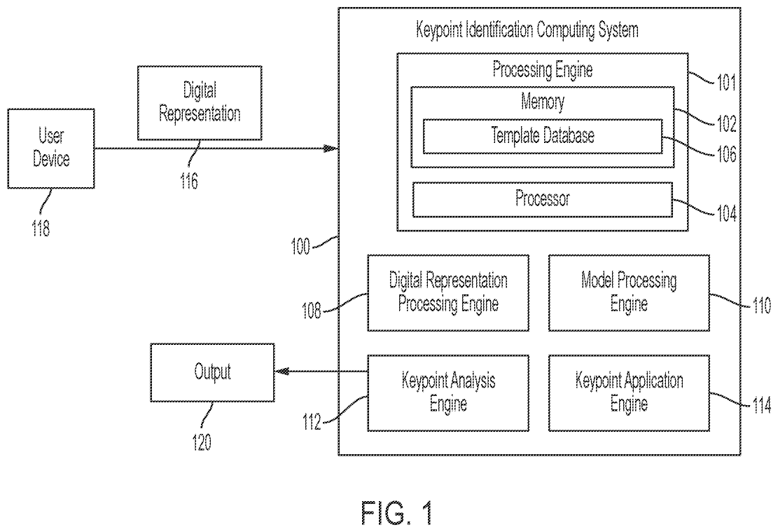

Referring to FIG. 1, a keypoint identification computing system 100 for detecting keypoints from a digital representation (e.g., 2D image) of a patient's dentition is shown, according to an exemplary embodiment. The keypoint identification computing system 100 is shown to include a processing engine 101. Processing engine 101 may include a memory 102 and a processor 104. The memory 102 (e.g., memory, memory unit, storage device) may include one or more devices (e.g., RAM, ROM, EPROM, EEPROM, optical disk storage, magnetic disk storage or other magnetic storage devices, flash memory, hard disk storage, or any other medium) for storing data and/or computer code for completing or facilitating the various processes, layers, and circuits described in the present disclosure. The memory 102 may be or include transitory memory or non-transitory memory, and may include database components, object code components, script components, or any other type of information structure for supporting the various activities and information structures described in the present disclosure. According to an illustrative embodiment, the memory 102 is communicably connected with the processor 104 and includes computer code for executing (e.g., by the processor 104) the processes described herein.

The memory 102 may include a template database 106. The template database 106 may include at least one template dentition model that indicates a generic orientation of a dentition not associated with a patient or user of the keypoint identification computing system 100. For example, a template dentition model may be a generic model that can be applied during orthodontic analysis of any user. The template dentition model may be based on population averages (e.g., average geometries, average tooth positions). In some embodiments, a template dentition model may correspond with a user with certain characteristics (e.g., age, race, ethnicity, etc.). For example, a first template dentition model may be associated with females and a second template dentition model may be associated with males. In some embodiments, a first template dentition model may be associated with a user under a predetermined age and a second template dentition model may be associated with a user over the predetermined age (e.g., a different model for children under 12 years old, for teenagers between 12-18 years old, and adults over 18 years old). A template dentition model may be associated with any number and any combination of user characteristics.

The processor 104 may be a general purpose single-chip or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor or any conventional processor, controller, microcontroller, or state machine. The processor 104 may also be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function.

The keypoint identification computing system 100 may include various modules or be comprised of a system of processing engines. The processing engine 101 may be configured to implement the instructions and/or commands described herein with respect to the processing engines. The processing engines may be or include any device(s), component(s), circuit(s), or other combination of hardware components designed or implemented to receive inputs for and/or automatically generate outputs based on an initial digital representation of an intraoral device. As shown in FIG. 1, in some embodiments, the keypoint identification computing system 100 may include a digital representation processing engine 108, a model processing engine 110, a keypoint analysis engine 112, and a keypoint application engine 114. While these engines 108-114 are shown in FIG. 1, it is noted that the keypoint identification computing system 100 may include any number of processing engines, including additional engines which may be incorporated into, supplement, or replace one or more of the engines shown in FIG. 1.

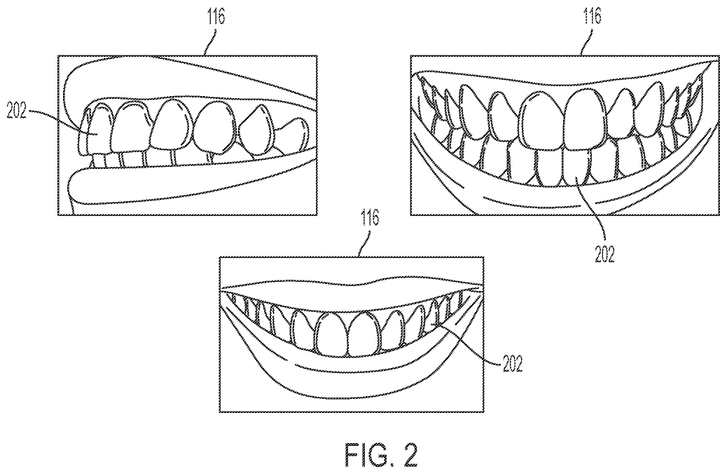

Referring now to FIGS. 1 and 2, the keypoint identification computing system 100 may be configured to receive at least one digital representation 116 of a user and to generate at least one output 120. For example, the digital representation processing engine 108 of the keypoint identification computing system 100 may be configured to receive at least one digital representation 116. The digital representation processing engine 108 may receive the digital representation 116 from a user device 118. The user device can be any device capable of capturing images (e.g., smart phone, camera, laptop, etc.). The digital representation 116 may include data corresponding to a user (e.g., a patient), and specifically a user's dentition. For example, the digital representation 116 may comprise a plurality of patient teeth 202.

In some embodiments, the digital representation processing engine 108 may receive a plurality of digital representations 116. For example, the digital representation processing engine 108 may receive a plurality of 2D images. In some embodiments, the plurality of digital representations 116 may include images of the user's dentition from different perspectives. For example, a first digital representation 116 may be a 2D image of a front view of the user's dentition and a second digital representation 116 may be a 2D image of a side view of the user's dentition. Based on a position of the user device 118 when capturing the 2D image, different patient teeth 202 can be visible in different images.

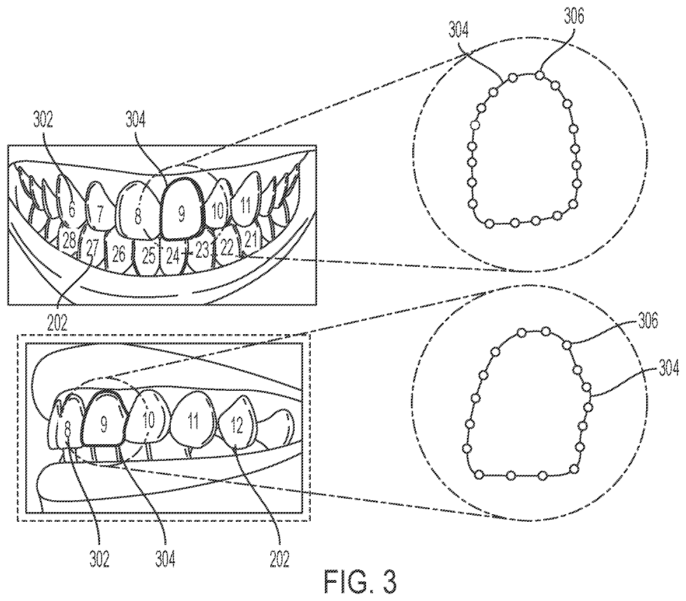

Referring now to FIGS. 1 and 3, the keypoint identification computing system 100 may be configured to segment a digital representation 116. For example, the digital representation processing engine 108 may be configured to segment the digital representation 116. Segmentation of a digital representation 116 may include identification of a patient tooth 202. For example, the digital representation 116 may include a plurality of patient teeth 202. The digital representation processing engine 108 may be configured to distinguish a first patient tooth 202 from a second patient tooth 202 in the digital representation 116. The digital representation processing engine 108 may be configured to identify a missing patient tooth 202. Segmentation of a digital representation 116 may include assigning a label 302 to the patient tooth 202. The label 302 may include a tooth number according to a standard, for example, the FDI World Dental Federation notation, the universal numbering system, Palmer notation, or any other labeling/naming convention. Segmentation of a digital representation 116 may include identification of a tooth outline 304 of a patient tooth 202. For example, the digital representation processing engine 108 may generate and/or identify a tooth outline of a patient tooth 202 in the digital representation 116. The tooth outline 304 may have a geometry that matches a perimeter (e.g., contour, edge) of a patient tooth 202 from a digital representation 116.

The digital representation processing engine 108 may be configured to segment a plurality of digital representations 116. For example, the digital representation processing engine 108 may segment a first digital representation 116 and a second digital representation 116. The digital representation processing engine 108 may be configured to identify the individual patient teeth 202 in the first digital representation 116 and the second digital representation 116. The digital representation processing engine 108 may be configured to identify a missing patient tooth 202 in the first digital representation 116 and the second digital representation 116. The digital representation processing engine 108 may identify a first tooth outline 304 of a patient tooth 202 from the first digital representation 116 and a second tooth outline 304 of the patient tooth 202 from the second digital representation 116. The first tooth outline 304 can be based on the same patient tooth 202 as the second tooth outline 304. A geometry of the first tooth outline 304 may be different than a geometry of the second tooth outline 304. For example, a perspective of the first digital representation 116 may be different from a perspective of the second digital representation 116, which may provide a different view of the same patient tooth 202 in each of the digital representations 116. The first tooth outline 304 may comprise a first set of tooth points 306 and the second tooth outline 304 may comprise a second set of tooth points 306. At least one tooth point 306 from the first set of tooth points 306 may be the same tooth point 306 as a tooth point 306 from the second set of tooth points 306. For example, a tooth point 306 from the first tooth outline 304 may correspond to a same location on the patient tooth 202 as a tooth point 306 from the second tooth outline 304.

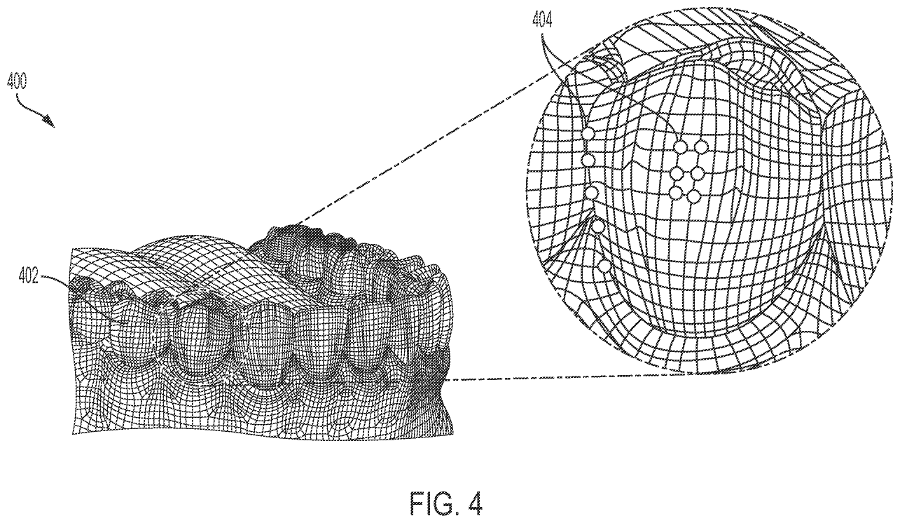

Referring now to FIGS. 1 and 4, the keypoint identification computing system 100 may be configured to retrieve a 3D mesh 400 of a dentition. For example, the model processing engine 110 may be configured to retrieve a 3D mesh 400 of a dentition. The 3D mesh 400 may include a plurality of model teeth 402. The 3D mesh 400 may be a template mesh. For example, a geometry of the 3D mesh 400 may not be associated with or based on a specific user. The geometry of the 3D mesh 400 may be based on at least one population average. The geometries of the model teeth 402 in the 3D mesh may be different than the geometries of the patient teeth 202 in the digital representations 116. In some embodiments, the 3D mesh may be a patient 3D mesh. For example, the geometry of the 3D mesh 400 may be associated with or based on a specific user. The geometries of the plurality of model teeth 402 in the patient 3D mesh 400 may be associated with or based on the geometries of the plurality of patient teeth 202 in the plurality of digital representations 116. The patient 3D mesh 400 may be based on data from a scan of the patient's dentition. The 3D mesh 400 may comprise a plurality of mesh points 404. For example, a mesh point 404 may correspond to a location on the 3D mesh. The 3D mesh 400 may be a polygon mesh comprising a collection of vertices, edges, and faces. The mesh points 404 can be located at any of the vertices, edges, or faces.

The model processing engine 110 may be configured to select a template 3D mesh 400 from a plurality of template 3D meshes 400. For example, the model processing engine 110 may select the template 3D mesh 400 based on at least one characteristic of the patient or the patient's dentition. For example, the characteristic may be a gender of the patient, an age of the patient, a race of the patient, or a size or geometry of the patient's teeth 202, among others. The model processing engine 110 may identify or detect the characteristic of the patient or may receive an input from the user device 118 indicating the characteristic. For example, the model processing engine 110 may measure at least one of the patient's teeth 202 from the digital representation 116 to determine a size of a tooth 202. The model processing engine 110 may receive input from the user device 118 indicating that the patient is a certain gender of a certain age. The model processing engine 110 may apply the data received and identified to select the template 3D mesh 400.

The model processing engine 110 may be configured to remove a model tooth 402 from the 3D mesh 400. For example, the digital representation processing engine 108 may be configured to identify a missing patient tooth 202 from a plurality of digital representations 116. Based on the digital representation processing engine 108 identifying a missing patient tooth 202, the model processing engine 110 may be configured to remove a model tooth 402 from the 3D mesh 400 that corresponds to the missing patient tooth 202. Removing the model tooth 402 from the 3D mesh can reduce the quantity of data analyzed by the keypoint identification computing system 100, and therefore reduce the overall processing load and processing time of the keypoint identification computing system 100.

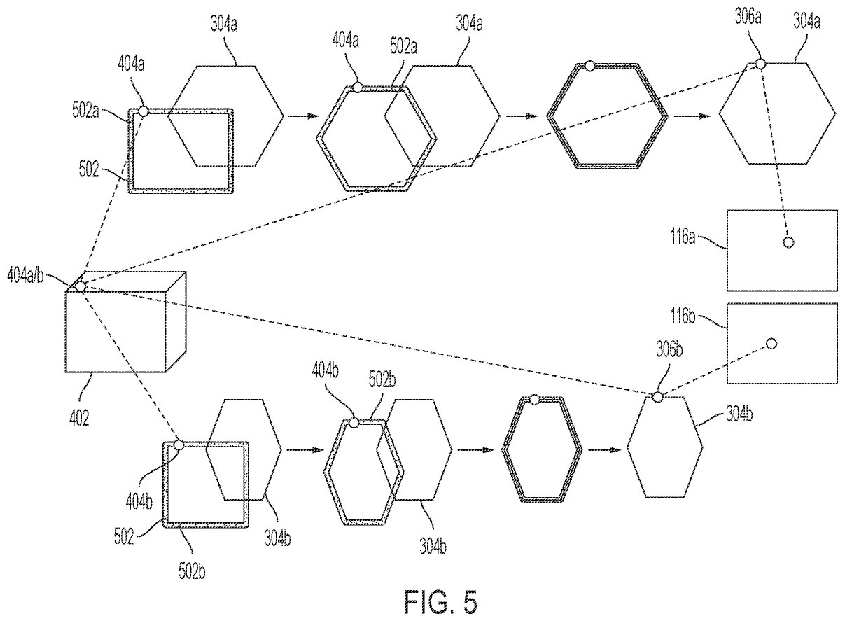

Referring now to FIGS. 1 and 5, the keypoint identification computing system 100 may be configured to identify or detect a keypoint. For example, the keypoint analysis engine 112 may be configured to identify a keypoint. The keypoint may be a tooth point 306 that has a reliable location with respect to the 3D mesh 400. The keypoint can be used for further analysis of a patient's dentition to provide more accurate and reliable results. To identify a keypoint, the keypoint analysis engine 112 may be configured to generate a mesh boundary 502. To generate a mesh boundary 502, the keypoint analysis engine 112 may be configured to determine at least one virtual camera parameter. The virtual camera parameter can include at least one of a position, orientation, field of view, aspect ratio, near plane, or far plane of the virtual camera. The virtual camera parameter may be based on a centroid of a patient tooth 202 and a centroid of a model tooth 402. Based on the virtual camera parameter, the keypoint analysis engine 112 may be configured to generate the mesh boundary 502. The mesh boundary 502 may have a geometry that matches a perimeter (e.g., contour, edge) of a model tooth 402 from the 3D mesh based on the virtual parameters. The mesh boundary 502 may comprise a subset of the plurality of mesh points 404. For example, the mesh boundary 502 may comprises the mesh points 404 disposed on the perimeter of the model tooth 402. The keypoint analysis engine 112 may be configured to generate a plurality of mesh boundaries 502. For example, the keypoint analysis engine 112 may be configured to generate a first mesh boundary 502 of a model tooth 402 based on a patient tooth 202 from a first digital representation 116 and a second mesh boundary 502 of the same model tooth 402 based on the same patient tooth 202 from a second digital representation 116. The first mesh boundary 502 and the second mesh boundary 502 may be based on the virtual camera parameters.

The keypoint analysis engine 112 may be configured to project a mesh boundary 502 of the model tooth 402 onto a patient tooth 202 from a digital representation 116. The model tooth 402 may correspond with the patient tooth 202. For example, the model tooth 402 may be a top right central incisor of the 3D mesh 400 and the patient tooth 202 may be a top right central incisor of the digital representation 116. The keypoint analysis engine 112 may be configured to project a plurality of mesh boundaries 502 onto the model tooth 402 from a plurality of digital representations 116. For example, as shown in FIG. 5, the keypoint analysis engine 112 may project a first mesh boundary 502a of a model tooth 402 onto a patient tooth 202 from a first digital representation 116 and a second mesh boundary 502b of the model tooth 402 onto the patient tooth 202 from a second digital representation 116. The first mesh boundary 502a may comprise a first subset of the plurality of mesh points 404 and the second mesh boundary 502b may comprise a second subset of the plurality of mesh points 404. The first subset and the second subset of the plurality of mesh points 404 may comprise at least one shared point. For example, a mesh point 404 from the plurality of mesh points 404 may be on both the first mesh boundary 502a and the second mesh boundary 502b.

The keypoint identification computing system 100 may identify a keypoint for a subset of a plurality of digital representations 116. For example, the keypoint analysis engine 112 may be configured to select a subset of the plurality of digital representations 116. The subset of digital representations 116 may be based on a quality of overlap between a tooth outline 304 and a mesh boundary 502. For example, the keypoint analysis engine 112 may select a digital representation 116 with a patient tooth 202 that has a tooth outline 304 that better matches a mesh boundary 502 than a digital representation 116 with a patient tooth 202 that has a tooth outline 304 that does not match the mesh boundary 502 as well. The subset of digital representations 116 may be based on a quantity of a patient tooth 202 shown in the digital representation 116. For example, the keypoint analysis engine 112 may select a digital representation 116 that shows a larger surface area of the patient tooth 202 than a digital representation 116 that shows a smaller surface area. The keypoint analysis engine 112 may select a subset of the plurality of digital representations 116 based on at least one of the quality of overlap or the quantity of surface area of the patient tooth shown.

The keypoint analysis engine 112 may be configured to modify a mesh boundary 502 to match a tooth outline 304. For example, the 3D mesh 400 may be a template mesh such that a geometry of mesh tooth 402 does not match a geometry of a patient tooth 202. As such, a geometry of a mesh boundary 502 may not match a geometry of a tooth outline 304. The keypoint analysis engine 112 may modify the mesh boundary 502 to match a tooth outline 304. For example, the keypoint analysis engine 112 may perform deformable edge registration to modify the mesh boundary. For example, the keypoint analysis engine 112 may be configured to deform the geometry of the mesh boundary 502 to match the geometry of the tooth outline 304. The keypoint analysis engine 112 may be configured to align the mesh boundary 502 with the tooth outline 304. Alignment of the mesh boundary 502 with the tooth outline 304 may include at least one of rotating, translating, or scaling the mesh boundary 502. The keypoint analysis engine 112 may be configured to modify the mesh boundary at a vertex and edge level such that relatively smaller or less geometrically significant features may be captured in addition to the tooth outline 304. With a plurality of digital representations 116, the keypoint analysis engine 112 may be configured to match a plurality of mesh boundaries 502 with a plurality of tooth outlines 304. For example, the keypoint analysis engine 112 may modify a first mesh boundary 502 to match a first tooth outline 304 and modify a second mesh boundary 502 to match a second tooth outline 304.

The keypoint analysis engine 112 may be configured to identify a tooth point 306 on the tooth outline 304 that corresponds with a mesh point 404 on the mesh boundary 502. For example, with the modified mesh boundary 502 matching the tooth outline 304, a tooth point 306 that overlaps with a mesh point 404 may correspond with the mesh point 404. With a plurality of digital representations 116, a first tooth point 306a on a first tooth outline 304a may correspond with a first mesh point 404a on a first mesh boundary 502a and a second tooth point 306b on a second tooth outline 304b may correspond with a second mesh point 404b on a second mesh boundary 502b.

The keypoint analysis engine 112 may be configured to register a tooth point 306 with a corresponding mesh point 404. For example, the keypoint analysis engine 112 may link the tooth point 306 with the corresponding mesh point 404. With a plurality of digital representations 116, a first mesh outline 502a may comprise a first subset of the plurality of mesh points 404 and a first tooth outline 304a may comprise a first set of tooth points 306. A second mesh outline 502b may comprise a second subset of the plurality of mesh points 404 and a second tooth outline 304b may comprise a second set of tooth points 306. The keypoint analysis engine 112 may register each of the mesh points 404a of the first subset of the plurality of mesh points 404 with a corresponding tooth point 306a of the first set of tooth points 306. The keypoint analysis engine 112 may register each of the mesh points 404b of the second subset of the plurality of mesh points 404b with a corresponding tooth point 306b of the second set of tooth points 306.

The keypoint analysis engine 112 may be configured to map a tooth point 306 from a tooth outline 304 to the 3D mesh 400 of the dentition. For example, a mesh point 404 may be associated with a specific location of the 3D mesh 400. The keypoint analysis engine 112 may map a tooth point 306 that is registered with or linked to a mesh point 404 back to the specific location of the 3D mesh 400 associated with the mesh point 404. With a plurality of digital representations 116, the keypoint analysis engine 112 may map a first tooth point 306a from a first tooth outline 304a to the 3D mesh 400 and map a second tooth point 306b from a second tooth outline 304b to the 3D mesh 400.

The keypoint analysis engine 112 may be configured to determine that a first tooth point 306a from a first tooth outline 304a and a second tooth point 306b from a second tooth outline 304b correspond to a common 3D mesh point 404. For example, the first tooth point 306a may correspond with a first mesh point 404a of a first mesh boundary 502a and the second tooth point 306b may correspond with a second mesh point 404b of a second mesh boundary 502b. The first and second mesh points 404a,b may correspond to the same specific location on the 3D mesh 400 (e.g., the first mesh point 404a is the same mesh point 404 as the second mesh point 404b), such that the keypoint analysis engine 112 may map the first tooth point 306a to a location on the 3D mesh 400 and map the second tooth point 306b to the same, or substantially the same location on the 3D mesh 400. As such, the keypoint analysis engine 112 may determine the first mesh point 404a and the second mesh point 404b correspond to a common 3D mesh point 404.

A common 3D mesh point 404 may include mesh points 404 that are within a predetermined threshold distance from each other. For example, the first mesh point 404a may not exactly align with the second mesh point 404b, but if the first mesh point 404a is within the predetermined threshold distance from the second mesh point 404, the keypoint analysis engine 112 may be configured to determine the mesh point 404a and the second mesh point 404b are a common 3D mesh point 404.

The keypoint analysis engine 112 may be configured to designate a keypoint. For example, the keypoint analysis engine 112 may be configured to designate at least one of the first tooth point 306a, the second tooth point 306b, and the common 3D mesh point 404 as a keypoint. For example, the keypoint analysis engine 112 may be configured to, responsive to determining the first tooth point 306a and the second tooth point 306b correspond to the same common 3D mesh point 404, designate the first tooth point 306a as a keypoint. Identifying the same mesh point 404 on different digital representations 116 can improve the identification of accurate keypoints on the patient teeth 202, which are generally featureless objects, by confirming that a tooth point 306 from a first digital representation 116 is also visible on a second digital representation 116, and each tooth point 306 corresponds to the same mesh point 404 of the 3D mesh 400.

The keypoint analysis engine 112 may be configured to identify and designate a plurality of keypoints. For example, a first tooth outline 304a from a first digital representation 116a may comprise a first set of tooth points 306. A second tooth outline 304b from a second digital representation 116b may comprise a second set of tooth points 306b. The keypoint analysis engine 112 may generate a first mesh boundary 502a with a first set of mesh points 404 to align with the first tooth outline 304a and generate a second mesh boundary 502b with a second set of mesh points 404 to align with the second tooth outline 304b. The first set of mesh points 404 may include a subset of mesh points 404 that are also included in the second set of mesh points 404 (e.g., both the first set and second set of mesh points 404 include the same subset of mesh points 404). As such, keypoint analysis engine 112 may map a subset of the first set of tooth points 306a to the 3D mesh 400 to locations that correspond to locations of the subset of the second set of tooth points 306b. The keypoint analysis engine 112 may designate at least one of the subset of the first set of tooth points 306a and a subset of the second set of tooth points 306b as keypoints.

The keypoint application engine 114 may be configured to store the designated keypoint(s). For example, the keypoint application engine 114 may store a designated keypoint in the memory 102 of the keypoint identification computing system 100. The keypoint may be associated with the digital representation 116 analyzed by the keypoint identification computing system 100. For example, the digital representation 116 including the keypoint may be stored in the memory 102.

Referring back to FIG. 1, the keypoint identification computing system 100 may be configured to apply a designated keypoint. For example, the keypoint application engine 114 may be configured to apply a designated keypoint for additional dentition analytics, image processing or 3D model creation, or treatment. For example, the keypoint application engine 114 may use a keypoint to update a virtual camera parameter. For example, the model processing engine 110 may use a centroid of a patient tooth 202 and a centroid of a mesh tooth 402 to identify an initial virtual camera parameter to generate an initial mesh boundary 502. Responsive to obtaining or identifying a keypoint, the keypoint application engine 114 may update the virtual camera parameter based on the keypoint and re-analyze a digital representation 116 based on the updated virtual camera parameter. For example, the keypoint analysis engine 112 may generate an updated mesh boundary 502 based on the updated virtual camera parameter. The updated mesh boundary 502 may be based on the same digital representation 116 as the initial mesh boundary 502, but may include at least one different mesh point 404 than the initial mesh boundary 502 based on the updated virtual camera parameter. The keypoint analysis engine 112 may be configured to identify another common 3D mesh point 404, or keypoint, based on the updated virtual camera parameter. The keypoint application engine 114 may update the virtual camera parameter upon detection of a new keypoint until a threshold is met. For example, the keypoint application engine 114 may update virtual camera parameters a predetermined number of times before completing analysis of the digital representation 116 or may update the virtual camera parameters until an error value reaches a predetermined value or plateaus. The keypoint analysis engine 112 may identify so many keypoints during this iterative process such that there is very little error between identified points on the digital representations 116 and the 3D mesh 400.

The keypoint application engine 114 may be configured to update a geometry of the 3D mesh 400 based on the keypoint. For example, the keypoint application engine 114 may be configured to modify a geometry of the 3D mesh 400 to accurately reflect a geometry of the patient teeth 202 in a plurality of digital representations 116. The keypoint may create a correlation between the digital representation and the 3D mesh (e.g., 2D-3D correspondence) such that the keypoint application engine 114 may adjust the 3D mesh 400 to match the patient teeth 202 in the digital representation 116. The keypoint application engine 114 may adjust the 3D mesh 400 or generate a new 3D mesh 400 by using similar processes to those described in U.S. Pat. No. 10,916,053, titled “Systems and Methods for Constructing a Three-Dimensional Model from Two-Dimensional Images,” filed Nov. 26, 2019 and U.S. Pat. No. 11,403,813, titled “Systems and Methods for Mobile dentition Scanning,” filed Nov. 25, 2020, the contents of each of which are incorporated herein by reference in their entireties. For example, the keypoint application engine 114 may generate a point cloud from the keypoints from the digital representations 116 to generate a 3D mesh 400 that matches the patient teeth 202 in the digital representation 116.

The keypoint application engine 114 may be configured to update a digital representation 116 based on the keypoint. For example, a patient tooth 202 in a first digital representation 116a may look slightly different than a patient tooth 202 in a second digital representation 116b due to camera parameters when the digital representations 116a,b are captured. The keypoint application engine 114 may be configured to use the keypoint to identify camera parameters and correct or adjust at least one of the first digital representation 116a or the second digital representation 116b to better reflect the actual geometry of the patient's teeth. For example, the keypoint application engine 114 may apply the keypoint to correct a distortion of a patient tooth 202 in at least one of the first digital representation 116a or the second digital representation 116b. For example, the keypoint application engine 114 may adjust a tooth outline 304 from a digital representation 116 to match a mesh boundary 502 of the 3D mesh 400.

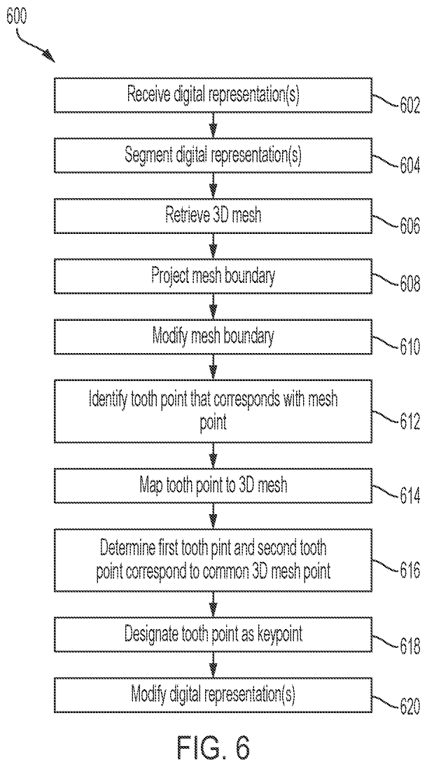

Referring now to FIG. 6, a method 600 of identifying a key point is shown, according to an exemplary embodiment. Method 600 may include receiving a digital representation (step 602), segmenting the digital representation (step 604), retrieving a 3D mesh (step 606), projecting a mesh boundary (step 608), modifying the mesh boundary (step 610), identifying a tooth point that corresponds with a mesh point (step 612), mapping the tooth point to the 3D mesh (step 614), determining a first tooth point and a second tooth point correspond to a common 3D mesh point (step 616), designating the first tooth point as a keypoint (step 618), and modifying a digital representation (step 620).

At step 602, one or more processors may receive a digital representation 116. For example, the digital representation processing engine 108 may receive a digital representation 116. The digital representation processing engine 108 may receive a plurality of digital representations 116. For example the digital representations 116 may include a first digital representation 116 and a second digital representation 116. The digital representation 116 may include a plurality of patient teeth 202. The digital representation 116 may be a 2D image. The digital representation 116 may be a video. The digital representation 116 may be captured by a user device. The digital representation 116 may be received from a user device 118.

At step 604, one or more processors may segment the digital representations 116. For example, the digital representation processing engine 108 may segment the digital representation 116. The digital representation processing engine 108 may segment the digital representations 116 to identify a tooth outline 304 of a patient tooth 202. The tooth outline 304 may include a plurality of tooth points 306. The digital representation processing engine 108 may identify a first tooth outline 304 of a patient tooth 202 from the first digital representation 116 and identify a second tooth outline 304 of the patient tooth 202 from the second digital representation 116. The first tooth outline 304 may be different than the second tooth outline 304. The first tooth outline 304 may comprise a first set of tooth points 306. The second tooth outline 304 may comprises a second set of tooth points 306.

At step 606, one or more processors may retrieve a 3D mesh. For example, the model processing engine 110 may retrieve a 3D mesh 400 of a dentition. The 3D mesh 400 may have a plurality of model teeth 402. The 3D mesh 400 may have a plurality of mesh points 404. In some embodiments, the model processing engine 110 may retrieve the 3D mesh 400 from the template database 106. The 3D mesh 400 may be a template mesh. For example, a geometry of the model teeth 402 of the 3D mesh 400 may be different than a geometry of the patient teeth 202 in the digital representation 116. The template 3D mesh 400 may be based on population averages (e.g., average geometries, average tooth positions). In some embodiments, the 3D mesh may be based on the patient's dentition. For example, the 3D mesh may be based on data from a scan of the patient's dentition. The 3D mesh 400 based on the patient's dentition may be stored in the memory 102 of the keypoint identification computing system 100 and the model processing engine 110 may be configured to retrieve the 3D mesh 400 from the memory 102.

Step 606 may include one or more processors modifying the 3D mesh 400. For example, the model processing engine 110 may identify a missing patient tooth 202 in the plurality of digital representations 116. Based on the identification of the missing patient tooth 202, the model processing engine 110 may remove a model tooth 402 from the plurality of model teeth 402 of the 3D mesh 400 that corresponds with the missing patient tooth 202.

At step 608, one or more processors may project a mesh boundary. For example, the model processing engine 110 may project a mesh boundary 502 of a model tooth 402 onto a patient tooth 202 from a digital representation. The model tooth 402 may correspond with the patient tooth 202. With more than one digital representation 116, the model processing engine 110 may project a first mesh boundary 502 of a model tooth 402 onto a patient tooth 202 from the first digital representation 116 and project a second mesh boundary 502 of the model tooth 402 onto the patient tooth 202 from a second digital representation 116. The first mesh boundary 502 may comprise a first subset of the plurality of mesh points 404 of the 3D mesh 400. The second mesh boundary 502 may comprise a second subset of the plurality of mesh points 404 of the 3D mesh 400. The first subset and the second subset of the plurality of mesh points 404 may include at least one shared mesh point 404.

Step 608 may include one or more processors generating the mesh boundary 502. The mesh boundary 502 may be based on a perimeter (e.g., contour, outline, edge) geometry of a model tooth 402. To generate the mesh boundary 502, the model processing engine 110 may determine a virtual camera parameter. The virtual camera parameter may be based on a centroid of a patient tooth 202 and a centroid of a model tooth 402 that corresponds with the patient tooth 202. Based on the virtual camera parameter, the model processing engine 110 may generate the mesh boundary 502. The model processing engine 110 may generate a plurality of mesh boundaries (e.g., the first mesh boundary 502 and the second mesh boundary 502) based, at least partially, on the virtual camera parameter.

Step 608 may include one or more processors selecting a subset of a plurality of digital representations 116. For example, the keypoint analysis engine 112 may select a subset of a plurality of digital representations 116 based on at least one of a quality of overlap between a tooth outline 304 and a mesh boundary 502 and a quantity of surface area of the patient tooth 202 shown in the digital representation 116. The subset may include digital representations 116 that have a tooth outline 304 that better matches a mesh boundary 502. The subset may include digital representations 116 that show a larger surface area of a patient tooth 202.

At step 610, one or more processors may modify the mesh boundary 502. For example, the keypoint analysis engine 112 may modify the mesh boundary 502 to match a tooth outline 304. With a plurality of digital representations 116, the keypoint analysis engine 112 may modify a plurality of mesh boundaries 502. For example, the keypoint analysis engine 112 may modify a first mesh boundary 502 to match a first tooth outline 304. The keypoint analysis engine 112 may modify a second mesh boundary 502 to match a second tooth outline 304. Modifying a mesh boundary 502 to match a tooth outline 304 may include deforming a geometry of the mesh boundary 502 to match a geometry of the tooth outline 304. Modifying a mesh boundary 502 may include aligning the mesh boundary 502 with the tooth outline 304. Aligning the mesh boundary 502 may include at least one of rotating, translating, or scaling the mesh boundary 502.

At step 612, one or more processors may identify a tooth point 306 that corresponds with a mesh point 404. For example, the keypoint analysis engine 112 may identify a tooth point 306 from a tooth outline 304 that corresponds with a mesh point 404 from a mesh boundary 502. With a plurality of digital representations 116, the keypoint analysis engine 112 may identify a first tooth point 306 on a first tooth outline 304 that corresponds with a first mesh point 404 from a first mesh boundary 502 and identify a second tooth point 306 on a second tooth outline 304 that corresponds with a second mesh point 404 from a second mesh boundary 502.

Step 612 may include one or more processors registering a mesh point 404 with a tooth point 306. For example, the keypoint analysis engine 112 may register some or all of the mesh points 404 of a mesh boundary 502 with a corresponding tooth point 306 of a tooth outline 304. With a plurality of digital representations 116, the keypoint analysis engine 112 may register some or all of the mesh points 404 of a first mesh boundary 502 with a corresponding tooth point 306 of a first tooth outline 304 and register some or all of the mesh points 404 of a second mesh boundary 502 with a corresponding tooth point 306 of a second tooth outline 304. Registering the tooth point 306 with the mesh point 404 may include linking the tooth point 306 with the mesh point 404.

At step 614, one or more processors may map a tooth point 306 to the 3D mesh 400. For example, the keypoint analysis engine 112 may map a tooth point 306 to the 3D mesh 400. A mesh point 404 may correspond with a specific location of the 3D mesh such that a tooth point 306 that corresponds with a mesh point 404 may map back to the 3D mesh 400 at that specific location. For example, a first tooth point 306 may correspond with a first mesh point 404 from a first mesh boundary 502. The first mesh point 404 may correspond to a first location on the 3D mesh 400. The keypoint analysis engine 112 may map the first tooth point 306 to the first location of the 3D mesh 400. A second tooth point 306 may correspond with a second mesh point 404 from a second mesh boundary 502. The second mesh point 404 may correspond to a second location on the 3D mesh 400. The keypoint analysis engine 112 may map the second tooth point 306 to the second location of the 3D mesh 400. The first location can be the same location as the second location or a different location. Mapping a tooth point 306 to the 3D mesh 400 may create a 2D-3D correspondence between the digital representation 116 and the 3D mesh 400.

At step 616, one or more processors may determine a first tooth point 306 and a second tooth point 306 correspond to a common 3D mesh point. For example, the keypoint analysis engine 112 may determine that a first tooth point 306 and a second tooth point 306 correspond to a common 3D mesh point. Step 616 may include determining that a first tooth point 306 from a first tooth outline 304 that corresponds with a first mesh point 404 from a first mesh boundary 502 maps to the same location on the 3D mesh 400 as a second tooth point 306 from a second tooth outline 304 that corresponds with a second mesh point 404 from a second mesh boundary 502. The keypoint analysis engine 112 may determine that the first mesh point 404 and the second mesh point 404 are the same mesh point 404.

At step 618, one or more processors may designate a tooth point 306 as a keypoint. For example, the keypoint analysis engine 112 may designate a tooth point 306 as a keypoint. Designation of the tooth point 306 as a keypoint may be responsive to determining a first mesh point 404 and a second mesh point 404 correspond to a common 3D mesh point 404. Step 618 may include applying the keypoint for additional dentition analysis. For example, the keypoint application engine 114 may update a virtual camera parameter based on the keypoint. The keypoint analysis engine 112 may use the updated virtual camera parameters to identify a second common 3D mesh point. The keypoint application engine 114 may modify a geometry of the 3D mesh 400 based on the keypoint such that the geometry of the 3D mesh accurately reflects the patient teeth 202 in the plurality of digital representations 116.

Step 618 may include storing the keypoint. For example, the keypoint application engine 114 may store the designated keypoint(s) in the memory 102. The keypoint may be stored in association with the digital representation 116. For example, the keypoint application engine 114 may store the digital representation 116 that includes the keypoint in the memory 102. In some embodiments, the keypoint may be stored in association with the 3D mesh 400. For example, the keypoint application engine 114 may store the 3D mesh 400 that includes the keypoint in the memory 102.

At step 620, one or more processors may modify a digital representation 116. For example, the keypoint analysis engine 112 may apply the keypoint to update or change a digital representation 116 to better reflect an actual geometry of a patient's dentition. Modifying the digital representation 116 may include correcting a distortion that is present in the digital representation 116 due to the camera parameters of the device used to capture the digital representation 116. Modifying the digital representation 116 may include adjusting virtual camera parameters based on the keypoint, generating a new mesh projection 502 based on the updated virtual camera parameters, and adjusting a tooth outline 304 to align with the new mesh projection 502 such that a geometry of the patient tooth 202 in the digital representation 116 matches a geometry of a corresponding model tooth 402.

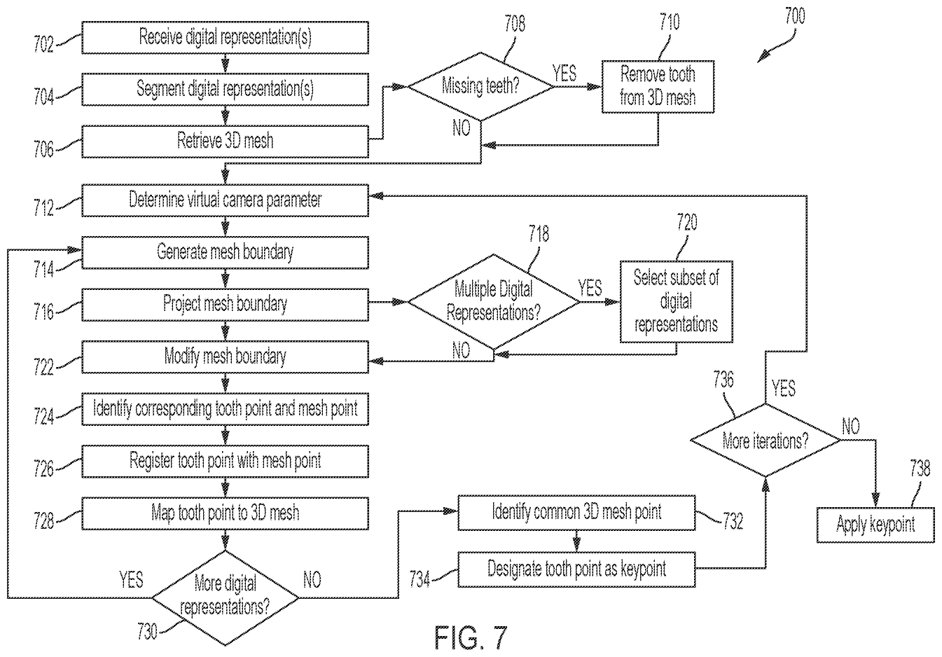

Referring now to FIG. 7, a method 700 of identifying a tooth keypoint is shown, according to an exemplary embodiment. Method 700 may include receiving a digital representation (step 702), segmenting the digital representation (step 704), retrieving a 3D mesh (step 706), and determining whether there are missing teeth in the digital representation (step 708). If there is a missing tooth identified in the digital representation, method 700 may include removing a tooth from the 3D mesh (step 710). The method may include determining a virtual camera parameter (step 712), generating a mesh boundary (step 714), projecting a mesh boundary 716, and determining whether there are multiple digital representations (step 718). If there are multiple digital representations, the method 700 may include selecting a subset of the digital representations (step 720). If there are not multiple digital representations or the system does not determine if there are multiple digital representations, the method 700 may include modifying the mesh boundary (step 722), identifying a corresponding tooth point and mesh point (step 724), registering the tooth point with the mesh point (step 726), mapping the tooth point to the 3D mesh (step 728), and determining if there are more digital representations (step 730). If there are more digital representations, method 700 may include repeating steps 714-730. If there are no more digital representations, method 700 may include determining a common 3D mesh point (step 732), designating a tooth point as a keypoint (step 734), and determining whether more iterations are to be performed (step 736). If more iterations are to be performed, method 700 may repeat steps 712-736 until there are no more iterations to be performed. If there are no more iterations to be performed, method 700 may include applying the keypoint (step 738).

At step 702, one or more processors may receive a digital representation 116. For example, the digital representation processing engine 108 may receive a digital representation 116. The digital representation processing engine 108 may receive a plurality of digital representations 116. For example the digital representations 116 may include a first digital representation 116 and a second digital representation 116. The digital representation 116 may include a plurality of patient teeth 202. The digital representation 116 may be a 2D image. The digital representation may be a video. The digital representation 116 may be captured by a user device. The digital representation 116 may be received from a user device 118.

At step 704, one or more processors may segment the digital representations 116. For example, the digital representation processing engine 108 may segment the digital representation 116. The digital representation processing engine 108 may segment the digital representations 116 to identify a tooth outline 304 of a patient tooth 202. The tooth outline 304 may include a plurality of tooth points 306. The digital representation processing engine 108 may identify a first tooth outline 304 of a patient tooth 202 from the first digital representation 116 and identify a second tooth outline 304 of the patient tooth 202 from the second digital representation 116. The first tooth outline 304 may be different than the second tooth outline 304. The first tooth outline 304 may comprise a first set of tooth points 306. The second tooth outline 304 may comprises a second set of tooth points 306.

At step 706, one or more processors may retrieve a 3D mesh. For example, the model processing engine 110 may retrieve a 3D mesh 400 of a dentition. The 3D mesh 400 may have a plurality of model teeth 402. The 3D mesh 400 may have a plurality of mesh points 404. The model processing engine 110 may retrieve the 3D mesh 400 from the template database 106. The 3D mesh 400 may be a template mesh. For example, a geometry of the model teeth 402 of the 3D mesh 400 may be different than a geometry of the patient teeth 202 in the digital representation 116. The template 3D mesh 400 may be based on population averages (e.g., average geometries, average tooth positions). In some embodiments, the 3D mesh may be based on patient data. The model processing engine 110 may retrieve a 3D mesh 400 associated with the patient from the memory 102. For example, a geometry of the model teeth 402 of the 3D mesh 400 may be associated with a geometry of the patient teeth 202 in the digital representation 116. The 3D mesh may be based on data from a 3D scan of the patient's dentition.

At step 708, one or more processors may identify a missing patient tooth 202 in the digital representation 116. For example, the model processing engine 110 may identify a missing patient tooth 202 in the digital representation 116. At step 710, if the model processing engine 110 identifies a missing patient tooth, the one or more processors may remove a model tooth 402 from the 3D mesh 400 that corresponds to the missing patient tooth 202. For example, the model processing engine 110 may remove the model tooth 402 from the 3D mesh 400.

At step 712, one or more processors may determine a virtual camera parameter. For example, the model processing engine 110 may determine a virtual camera parameter. The virtual camera parameter may be based on a centroid of a patient tooth 202 and a centroid of a model tooth 402 that corresponds with the patient tooth 202.

At step 714, one or more processors may generate a mesh boundary 502. For example, the model processing engine 110 may generate the mesh boundary 502. The model processing engine 110 may generate a plurality of mesh boundaries (e.g., a first mesh boundary 502 and a second mesh boundary 502). The mesh boundaries 502 may be based, at least partially, on the virtual camera parameter.

At step 716, one or more processors may project a mesh boundary. For example, the model processing engine 110 may project a mesh boundary 502 of a model tooth 402 onto a patient tooth 202 from a digital representation. The model processing engine 110 may project a first mesh boundary 502 of a model tooth 402 onto a patient tooth 202 from the first digital representation 116 and project a second mesh boundary 502 of the model tooth 402 onto the patient tooth 202 from a second digital representation 116. The first mesh boundary 502 may comprise a first subset of the plurality of mesh points 404 of the 3D mesh 400. The second mesh boundary 502 may comprise a second subset of the plurality of mesh points 404 of the 3D mesh 400. The first subset and the second subset of the plurality of mesh points 404 may include at least one shared mesh point 404.

At step 718, one or more processors may determine whether there are a plurality of digital representations 116. For example, the keypoint analysis engine 112 may determine whether there are a plurality of digital representations 116. At step 720, if the keypoint analysis engine 112 determines there are a plurality of digital representations 116, the keypoint analysis engine 112 may select a subset of the digital representations 116. For example, the keypoint analysis engine 112 may select a subset of a plurality of digital representations 116 based on at least one of a quality of overlap between a tooth outline 304 and a mesh boundary 502 and a quantity of surface area of the patient tooth 202 shown in the digital representation 116. The subset may include digital representations 116 that have a tooth outline 304 that better matches a mesh boundary 502. The subset may include digital representations 116 that show a larger surface area of a patient tooth 202.

At step 722, the one or more processors may modify the mesh boundary 502. For example, the keypoint analysis engine 112 may modify the mesh boundary 502 to match a tooth outline 304. With a plurality of digital representations 116, the keypoint analysis engine 112 may modify a plurality of mesh boundaries 502. For example, the keypoint analysis engine 112 may modify a first mesh boundary 502 to match a first tooth outline 304. The keypoint analysis engine 112 may modify a second mesh boundary 502 to match a second tooth outline 304. Step 722 may include deforming a geometry of the mesh boundary 502 to match a geometry of the tooth outline 304. Step 722 may include aligning the mesh boundary 502 with the tooth outline 304. Aligning the mesh boundary 502 may include at least one of rotating, translating, or scaling the mesh boundary 502.

At step 724, one or more processors may identify a tooth point 306 that corresponds with a mesh point 404. For example, the keypoint analysis engine 112 may identify a tooth point 306 from a tooth outline 304 that corresponds with a mesh point 404 from a mesh boundary 502. With a plurality of digital representations 116, the keypoint analysis engine 112 may identify a first tooth point 306 on a first tooth outline 304 that corresponds with a first mesh point 404 from a first mesh boundary 502 and identify a second tooth point 306 on a second tooth outline 304 that corresponds with a second mesh point 404 from a second mesh boundary 502.

At step 726, one or more processors may register a mesh point 404 with a tooth point 306. For example, the keypoint analysis engine 112 may register some or all of the mesh points of a mesh boundary 502 with a corresponding tooth point 306 of a tooth outline 304. With a plurality of digital representations 116, the keypoint analysis engine 112 may register some or all of the mesh points 404 of a first mesh boundary 502 with a corresponding tooth point 306 of a first tooth outline 304 and register some or all of the mesh points 404 of a second mesh boundary 502 with a corresponding tooth point 306 of a second tooth outline 304.

At step 728, one or more processors may map a tooth point 306 to the 3D mesh 400. For example, the keypoint analysis engine 112 may map a tooth point 306 to the 3D mesh 400. A mesh point 404 may correspond with a specific location of the 3D mesh such that a tooth point 306 that corresponds with a mesh point 404 may map back to the 3D mesh 400 at that specific location. For example, a first tooth point 306 may correspond with a first mesh point 404 from a first mesh boundary 502. The first mesh point 404 may correspond to a first location on the 3D mesh 400. The keypoint analysis engine 112 may map the first tooth point 306 to the first location of the 3D mesh 400. A second tooth point 306 may correspond with a second mesh point 404 from a second mesh boundary 502. The second mesh point 404 may correspond to a second location on the 3D mesh 400. The keypoint analysis engine 112 may map the second tooth point 306 to the second location of the 3D mesh 400. The first location can be the same location as the second location or a different location. Step 728 may include creating a 2D-3D correspondence between a digital representation 116 and a 3D mesh 400.

At step 730, one or more processors may determine whether there are additional digital representations 116. For example, the keypoint analysis engine 112 may determine whether there are additional digital representations 116. Responsive to determining there are additional digital representation 116, the keypoint analysis engine 112 may repeat steps 714-730 for at least some of the additional digital representations 116.

At step 732, one or more processors may identify a common 3D mesh point 404. For example, the keypoint analysis engine 112 may identify a common 3D mesh point 404. The keypoint analysis engine 112 may determine that a first tooth point 306 from a first tooth outline 304 that corresponds with a first mesh point 404 from a first mesh boundary 502 maps to the same location on the 3D mesh 400 as a second tooth point 306 from a second tooth outline 304 that corresponds with a second mesh point 404 from a second mesh boundary 502. The keypoint analysis engine 112 may determine that the first mesh point 404 and the second mesh point 404 are the same mesh point 404. The keypoint analysis engine 112 may identify the first and second mesh point 404 of the 3D mesh 400 as the common 3D mesh point 404.

At step 734, one or more processors may designate a tooth point 306 as a keypoint. For example, the keypoint analysis engine 112 may designate a tooth point 306 as a keypoint. Designation of the tooth point 306 as a keypoint may be responsive to determining a first mesh point 404 and a second mesh point 404 correspond to a common 3D mesh point 404.

At step 736, one or more processors may determine whether more iterations of the dentition analysis are to be performed. For example, the keypoint application engine 114 may determine whether more iterations are to be performed. The determination may be based on a predetermined threshold. For example, the steps may be repeated a predetermined number of times or may be repeated until an error value reaches a predetermined value or plateaus. When more iterations are to be performed, method 700 may return to step 712 such that the keypoint application engine 114 may update a virtual camera parameter based on the keypoint. The keypoint analysis engine 112 may use the updated virtual camera parameters to identify a second common 3D mesh point via steps 712-734. Steps 712-736 may be repeated until no more iterations are to be performed.

At step 738, one or more processors may apply a designated keypoint. For example, the keypoint application engine 114 may apply the keypoint for additional data analysis or manipulation. For example, the keypoint application engine 114 may use the keypoint for additional dentition analytics, image processing or 3D model creation, or treatment as disclosed herein. For example, based on a tooth point 306 being designated as a keypoint, the one or more processors may store the keypoint in the memory 102 and in association with the digital representations 116 of the user. For example, the one or more digital representations 116 including one or more keypoints may be stored in the memory 102.

In some embodiments, step 738 may include the keypoint application engine 114 modifying a geometry of the 3D mesh 400 based on the keypoint such that the geometry of the 3D mesh accurately reflects the patient teeth 202 in the plurality of digital representations 116. The modified 3D mesh may be stored in the memory 102. In some embodiments, step 738 may include the keypoint application engine 114 modifying the digital representation 116 based on one or more keypoints to more closely match the 3D model teeth 402. The modified digital representation 116 may be stored in the memory 102. The digital representation 116 may be modified by, for example, correcting or reversing a distortion of the digital representation 116 caused by parameters of the device used to capture the digital representation 116. For example, the keypoint application engine 114 may adjust a tooth outline 304 from a digital representation 116 to match a mesh boundary 502 of the 3D mesh 400.

The embodiments described herein have been described with reference to drawings. The drawings illustrate certain details of specific embodiments that provide the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As utilized herein, terms of degree such as “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to any precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that terms such as “exemplary,” “example,” and similar terms, as used herein to describe various embodiments, are intended to indicate that such embodiments are possible examples, representations, or illustrations of possible embodiments, and such terms are not intended to connote that such embodiments are necessarily extraordinary or superlative examples.

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any element on its own or any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the drawings. It should be noted that the orientation of various elements may differ according to other exemplary embodiments, and that such variations are intended to be encompassed by the present disclosure.

As used herein, terms such as “engine” or “circuit” may include hardware and machine-readable media storing instructions thereon for configuring the hardware to execute the functions described herein. The engine or circuit may be embodied as one or more circuitry components including, but not limited to, processing circuitry, network interfaces, peripheral devices, input devices, output devices, sensors, etc. In some embodiments, the engine or circuit may take the form of one or more analog circuits, electronic circuits (e.g., integrated circuits (IC), discrete circuits, system on a chip (SOCs) circuits, etc.), telecommunication circuits, hybrid circuits, and any other type of circuit. In this regard, the engine or circuit may include any type of component for accomplishing or facilitating achievement of the operations described herein. For example, an engine or circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

An engine or circuit may be embodied as one or more processing circuits comprising one or more processors communicatively coupled to one or more memory or memory devices. In this regard, the one or more processors may execute instructions stored in the memory or may execute instructions otherwise accessible to the one or more processors. The one or more processors may be constructed in a manner sufficient to perform at least the operations described herein. In some embodiments, the one or more processors may be shared by multiple engines or circuits (e.g., engine A and engine B, or circuit A and circuit B, may comprise or otherwise share the same processor which, in some example embodiments, may execute instructions stored, or otherwise accessed, via different areas of memory).

Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be provided as one or more suitable processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given engine or circuit or components thereof may be disposed locally (e.g., as part of a local server, a local computing system, etc.) or remotely (e.g., as part of a remote server such as a cloud based server). To that end, engines or circuits as described herein may include components that are distributed across one or more locations.

An example system for providing the overall system or portions of the embodiments described herein might include one or more computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example embodiments described herein.

Although the drawings may show and the description may describe a specific order and composition of method steps, the order of such steps may differ from what is depicted and described. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions, and arrangement of the embodiments without departing from the scope of the present disclosure as expressed in the appended claims.

What is claimed is:

1. A method, comprising:
receiving, by one or more processors, a plurality of digital representations comprising a plurality of patient teeth, the plurality of digital representations comprising a first digital representation and a second digital representation;
segmenting, by the one or more processors, the first digital representation and the second digital representation to identify a first tooth outline of a patient tooth from the first digital representation and a second tooth outline of the patient tooth from the second digital representation;
retrieving, by the one or more processors, a 3D mesh of a dentition comprising a plurality of model teeth;
projecting, by the one or more processors, a first mesh boundary of a model tooth of the plurality of model teeth onto the patient tooth from the first digital representation, the model tooth corresponding with the patient tooth;
modifying, by the one or more processors, the first mesh boundary to match the first tooth outline;
identifying, by the one or more processors, a first tooth point on the first tooth outline that corresponds with a first mesh point on the first mesh boundary;
mapping, by the one or more processors, the first tooth point to the 3D mesh of the dentition;
determining, by the one or more processors, that the first tooth point and a second tooth point correspond to a common 3D mesh point, the second tooth point having been mapped to the 3D mesh of the dentition based on the second tooth outline;
designating, by the one or more processors, based on determining the first tooth point and the second tooth point correspond to the common 3D mesh point, at least one of the first tooth point or the second tooth point as a keypoint; and
modifying, by the one or more processors, at least one of the first digital representation or the second digital representation based on the keypoint.

2. The method of claim 1, further comprising:
projecting, by the one or more processors, a second mesh boundary of the model tooth onto the patient tooth from the second digital representation;
modifying, by the one or more processors, the second mesh boundary to match the second tooth outline;
identifying, by the one or more processors, the second tooth point on the second tooth outline corresponds with a mesh point on the second mesh boundary; and
mapping, by the one or more processors, the second tooth point to the 3D mesh of the dentition.

3. The method of claim 1, wherein:
the 3D mesh comprises a plurality of mesh points;
the first mesh boundary comprises a first subset of the plurality of mesh points, including the first mesh point; and
a second mesh boundary comprises a second subset of the plurality of mesh points, including a second mesh point,
the first subset and the second subset of the plurality of mesh points comprising at least one shared mesh point, the at least one shared mesh point including the first mesh point and the second mesh point.

4. The method of claim 3, wherein the first tooth outline comprises a first set of tooth points and the second tooth outline comprises a second set of tooth points, the method further comprising:
registering, by the one or more processors, each of the mesh points of the first subset of the plurality of mesh points with a corresponding tooth point of the first set of tooth points; and
registering, by the one or more processors, each of the mesh points of the second subset of the plurality of mesh points with a corresponding tooth point of the second set of tooth points.

5. The method of claim 1, further comprising:
determining, by the one or more processors, a virtual camera parameter based on a centroid of the patient tooth and a centroid of the model tooth;
generating, by the one or more processors, the first mesh boundary and a second mesh boundary of the model tooth based on the virtual camera parameter;
updating, by the one or more processors, the virtual camera parameter based on the keypoint; and
identifying, by the one or more processors, a second common 3D mesh point based on the updated virtual camera parameter.

6. The method of claim 1, wherein modifying the first mesh boundary to match the first tooth outline comprises:
deforming, by the one or more processors, a geometry of the first mesh boundary to match a geometry of the first tooth outline; and
aligning, by the one or more processors, the first mesh boundary with the first tooth outline, wherein aligning the first mesh boundary with the first tooth outline comprises at least one of rotating, translating, or scaling the first mesh boundary.

7. The method of claim 1, further comprising modifying, by the one or more processors, a geometry of the 3D mesh based on the keypoint such that the geometry of the 3D mesh accurately reflects the plurality of patient teeth in the plurality of digital representations.

8. The method of claim 1, wherein the plurality of digital representations are 2D images captured by and received from a user device.

9. The method of claim 1, wherein the 3D mesh is a template mesh based on population averages, wherein geometries of the plurality of model teeth in the template mesh are different than geometries of the plurality of patient teeth in the plurality of digital representations.

10. The method of claim 1, wherein the 3D mesh is a patient mesh based on data from a scan of the patient's dentition, wherein geometries of the plurality of model teeth in the patient mesh are associated with the geometries of the plurality of patient teeth in the plurality of digital representations.

11. The method of claim 1, further comprising:
identifying, by the one or more processors, a missing patient tooth in the plurality of digital representations; and
removing, by the one or more processors, a corresponding model tooth of the plurality of model teeth from the 3D mesh, the corresponding model tooth corresponding with the missing patient tooth.

12. The method of claim 1, further comprising selecting, by the one or more processors, a subset of the plurality of digital representations based on at least one of a quality of overlap between the first tooth outline and the first mesh boundary and a quantity of surface area of the patient tooth shown, wherein the first digital representation and the second digital representation are a part of the subset of the plurality of digital representations.

13. A system comprising:
one or more processors; and
a memory coupled with the one or more processors, wherein the memory is configured to store instructions that, when executed by the one or more processors, cause the one or more processors to:
receive a plurality of digital representations comprising a plurality of patient teeth, the plurality of digital representations comprising a first digital representation and a second digital representation;
segment the first digital representation and the second digital representation to identify a first tooth outline of a patient tooth from the first digital representation and a second tooth outline of the patient tooth from the second digital representation;
retrieve a 3D mesh of a dentition comprising a plurality of model teeth;
project a first mesh boundary of a model tooth of the plurality of model teeth onto the patient tooth from the first digital representation, the model tooth corresponding with the patient tooth;
modify the first mesh boundary to match the first tooth outline;
identify a first tooth point on the first tooth outline that corresponds with a first mesh point on the first mesh boundary;
map the first tooth point to the 3D mesh of the dentition;
determine that the first tooth point and a second tooth point correspond to a common 3D mesh point, the second tooth point having been mapped to the 3D mesh of the dentition based on the second tooth outline;
designate at least one of the first tooth point or the second tooth point as a keypoint based on the first tooth point and the second tooth point corresponding to the common 3D mesh point; and
modify at least one of the first digital representation or the second digital representation based on the keypoint.

14. The system of claim 13, wherein the instructions, when executed by the one or more processors, further cause the one or more processors to:
project a second mesh boundary of the model tooth onto the second digital representation;
modify the second mesh boundary to match the second tooth outline;
identify a second mesh point on the second mesh boundary that corresponds with a tooth point on the second tooth outline; and
map the second mesh point to the 3D mesh of the dentition.

15. The system of claim 13, wherein:
the 3D mesh comprises a plurality of mesh points;
the first mesh boundary comprises a first subset of the plurality of mesh points, including the first mesh point; and
a second mesh boundary comprises a second subset of the plurality of mesh points, including a second mesh point,
the first subset and the second subset of the plurality of mesh points comprising at least one shared mesh point, the at least one shared mesh point including the first mesh point and the second mesh point.

16. The system of claim 15, wherein:
the first tooth outline comprises a first set of tooth points and the second tooth outline comprises a second set of tooth points; and
the instructions, when executed by the one or more processors, further cause the one or more processors to:
register each of the mesh points of the first subset of the plurality of mesh points with a corresponding tooth point of the first set of tooth points; and
register each of the mesh points of the second subset of the plurality of mesh points with a corresponding tooth point of the second set of tooth points.

17. The system of claim 13, wherein the instructions, when executed by the one or more processors, further cause the one or more processors to:
determine a virtual camera parameter based on a centroid of the patient tooth and a centroid of the model tooth;
generate the first mesh boundary and a second mesh boundary of the model tooth based on the virtual camera parameter;
update the virtual camera parameter based on the keypoint; and
identify a second common point based on the updated virtual camera parameter.

18. The system of claim 13, wherein the instructions, when executed by the one or more processors, further cause the one or more processors to:
deform a geometry of the first mesh boundary to match a geometry of the first tooth outline; and
align the first mesh boundary with the first tooth outline, wherein aligning the first mesh boundary with the first tooth outline comprises at least one of rotating, translating, or scaling the first mesh boundary.

19. A non-transitory computer readable medium storing instructions that, when executed by one or more processors, cause the one or more processors to:
receive a plurality of digital representations comprising a plurality of patient teeth, the plurality of digital representations comprising a first digital representation and a second digital representation;
segment the first digital representation and the second digital representation to identify a first tooth outline of a patient tooth from the first digital representation and a second tooth outline of the patient tooth from the second digital representation;
retrieve a 3D mesh of a dentition comprising a plurality of model teeth;
project a first mesh boundary of a model tooth of the plurality of model teeth onto the patient tooth from the first digital representation, the model tooth corresponding with the patient tooth;
modify the first mesh boundary to match the first tooth outline;
identify a first tooth point on the first tooth outline that corresponds with a first mesh point on the first mesh boundary;
map the first tooth point to the 3D mesh of the dentition;
determine that the first tooth point and a second tooth point correspond to a common 3D mesh point, the second tooth point having been mapped to the 3D mesh of the dentition based on the second tooth outline;
designate at least one of the first tooth point or the second tooth point as a keypoint based on the first tooth point and the second tooth point corresponding to the common 3D mesh point; and
modify at least one of the first digital representation or the second digital representation based on the keypoint.

20. The system of claim 19, wherein the instructions, when executed by the one or more processors, further cause the one or more processors to:
project a second mesh boundary of the model tooth onto the second digital representation;
modify the second mesh boundary to match the second tooth outline;
identify a second mesh point on the second mesh boundary that corresponds with a tooth point on the second tooth outline; and
map the second mesh point to the 3D mesh of the dentition.
